(19) United States
(12) Patent Application Publication
(10) Pub. No.: US 2002/0011946 A1
(43) Pub. Date: Jan. 31, 2002

(54) Device to conceal a radar fitted especially into an automobile

(75) Inventors: Jean-Paul Artis, Plouzane (FR); Thierry Dousset, Saint -Gratien (FR); Patrick Le Sayec, Montfort L'Amaury (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THOMSON-CSF, Paris (FR)

(21) Appl. No.: 09/879,085

(22) Filed: Jun. 13, 2001

(30) Foreign Application Priority Data
Jun. 14, 2000 (FR) 00 07733

(51) Int. Cl. G01S 7/38

(52) U.S. Cl. 342/13; 342/3; 342/4; 342/175; 342/198

(57) ABSTRACT

A device to conceal a radar fitted into an automobile comprises at least one system of conductive wires perpendicular to the polarization of the wave sent out by the radar and reproducing a given graphic representation The graphic representation may be the automobile manufacturer's logo. The disclosed device can be applied especially to radars positioned in from of vehicles, for example of the ACC type.

### BACKGROUND OF THE INVENTION

1. Field of the Invention

The present invention relates to a device to conceal a radar fitted into a vehicle or an automobile. It can be applied especially to radars positioned in the front of vehicles, for example ACC type radars.

For reasons of security especially, automobiles are equipped with radars. An exemplary known radar is the ACC or “Automotive Cruise Control” radar. A radar of this kind is used especially to control the speed of vehicles as a function of traffic. In other words, the radar detects the speed and distance of the vehicles preceding the carrier vehicle so as to maintain especially a safety distance between the vehicles. The radar can also be used to determine obstacles in the path of the vehicle.

This radar must therefore be integrated into the front of the automobile in a preferred position which, for example, could be behind the radiator cowl, straight on the usual position of the manufacturer's logo. In this case, the means used to conceal the radar should achieve the following goals all at once:

they should let through microwaves with as little attenuation as possible;

they should take graphics, namely a logo which, depending on the manufacturers, may have a shining chromium or gold type appearance for example.

One prior art approach makes use of an extremely thin chromium-plating on the plastic or polycarbonate substrate. This technique gives good results since the logo can be seen or distinguished without any problem and without confusion. However, it has a first drawback because this logo causes residual energy losses which may easily attain several decibels. The increase in the requirements of range and quality of detection of the new generations of radar are making this type of technique excessively penalizing and even inapplicable. Furthermore, a second drawback lies in the fact that this technique cannot be used to reproduce all the logos already known or used, especially those that have a gold appearance. Since a logo is especially a graphic representation of a commercial mark, it needs to be reproduced as faithfully as possible. It is especially a very important token of recognition for automobiles.

### SUMMARY OF THE INVENTION

It is an aim of the invention to overcome the above-mentioned drawbacks. To this end, an object of the invention is a device to conceal a radar fitted into an automobile, wherein the radar comprises at least one system of conductive wires perpendicular to the polarization of the wave sent out by the radar and reproducing a given graphic representation.

The system of wires may advantageously reproduce the automobile manufacturer's logo.

To further improve the reproduction of the graphics or logo, the device may comprise at least two systems of wires that are superimposed and offset. The two systems may preferably be offset by a half pitch.

The systems may be made by etching or metallization on substrates.

Advantageously, the wires of a system may consist of a wide variety of metals. For example, they may be made of chromium, copper, silver or gold.

The wires may be traversed by an electrical current, thus advantageously enabling the logo to be defrosted.

### BRIEF DESCRIPTION OF THE DRAWINGS

Other features and advantages of the invention shall appear from the following description, made with reference to be appended drawings, of which:

FIG. 1 shows a first possible embodiment of a device according to the invention;

FIG. 2 shows another possible embodiment of a device according to the invention used especially to increase the shining effect.

### MORE DETAILED DESCRIPTION

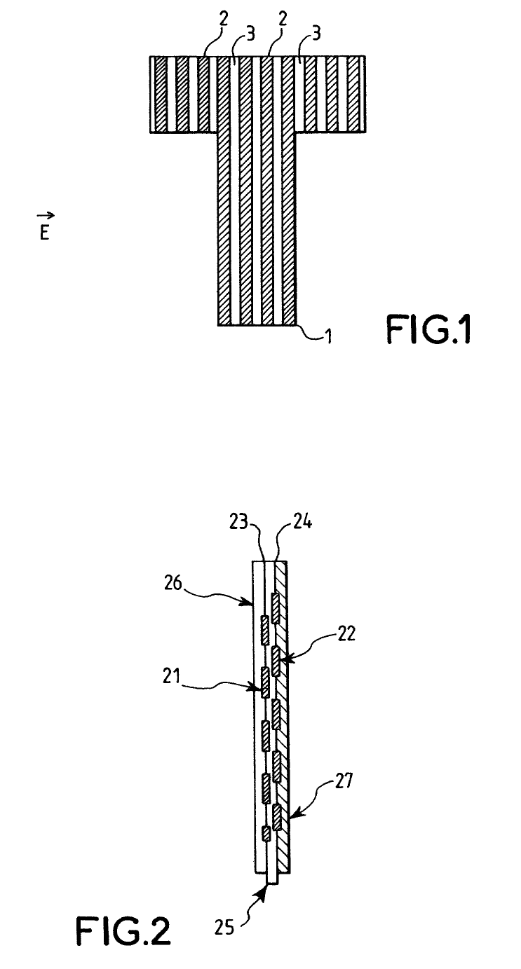

FIG. 1 gives a schematic view of an exemplary embodiment of the device according to the invention used to cover an automobile radar. This device 1 has a system of conductive zones to having a direction substantially perpendicular to the polarization of the wave emitted by the radar, namely a direction perpendicular to the electrical field \vec{E} of the wave. This cover I may also comprises a system of conductive wires 2 perpendicular to the polarization of the wave sent out by the radar.

Advantageously, the cover 1 may reproduce the emblem or logo of the manufacturer of the vehicle. Owing to the small wavelength of the band allocated to the automobile radar, the system of wires may be extremely thin and may thus faithfully reproduce the logo in the usual way, namely without any break or interruption. In particular, the system of wires may have a shining appearance similar to that of chromium that is solid or without any break of the kind commonly used.

For example, on a polycarbonate substrate, the width of the conductive zones 2 or wires may be in the range of 0.15 mm, as also the spacing 3 between two edges of the consecutive zones or consecutive wires. An arrangement of the wires of the system of this kind introduces microwaves losses as well as a negligible phase rotation. This makes it possible especially to avoid excessively modifying the radiation characteristics of the antenna of the radar.

This system of wires 2 may be deposited on a support by any metallization or etching technique. The etching precision required is compatible with techniques that can be used for large-scale production.

Given especially the fact that the resistivity of a conductive wire have little effect on the wave process, the system of wires may be made of a wide variety of metals, especially chromium, copper, silver or gold. The conductive wires may thus be constituted by these metals or lined with them. This makes it possible especially to obtain a variety of effects and reproduce a large quantity of logos.

An optically transparent substrate protects for example the system of wires against external adverse action, especially climatic or mechanical adverse action. This substrate is of course transparent to microwaves.

FIG. 2 illustrates another possible embodiment of a cover according to the invention. The system of wires as described with reference to FIG. 1 may have an appearance that may be deemed to be insufficiently shiny owing to the presence of the non-metallized zones 3. More generally, it may happen that this system, even though its contour is identical to that of a given logo, does not reproduce this logo with sufficient fidelity.

According to the invention, it is possible to create a cover with a continuous or uninterrupted appearance or a cover that approaches such an appearance. This can be done by superimposing at least two systems of wires 21, 22 which are, for example, offset. The two systems are thus for example offset by a half pitch. Thus, if the width of wires is for example 0.15 mm and the length of the spacing between wires in 0.50 mm, the pitch is equal to 20.30 mm. More generally, a pitch of the system corresponds to the width of a wire 2 plus the width of a spacing 3. The spacing between the two planes 23, 24 of the system is adapted to the wavelength in the substrate 25 between the two systems.

The first system of wires 21 is therefore separated from the second system of wires 22 by a median substrate 25 that is transparent to the optical waves and to the microwaves. A protection substrate 26 protects for example the first system of wires 21 located towards the exterior of the vehicle. A bottom substrate 27 that is transparent to the microwaves sandwiches the second system of wires 22 with the median substrate 25. Preferably, the bottom substrate 27 is not transparent to the optical waves. The first system of wires 21 is for example fixed to the median substrate 25, for example by metallization. The second system of wires 22 is for example fixed to the bottom substrate 27, for example by metallization.

It may be necessary to meet certain sizing constraints. In particular, the thickness of the median substrate 25 should be matched with that of the two systems of wires. The SWR (standing wave ratio) of the assembly formed by the two systems 21, 22 and of the substrate 25 must be as close as possible to 1 at the frequency of the radar. In particular, when the two systems are offset by a half pitch, the calculations and experiments performed by the Applicant have shown that this condition is suitably approached when the distance between the two systems is in the range of λ/2., where λ is the radar wavelength in the median substrate 25. This corresponds to a distance or thickness of about 2 mm in air or about 1 mm in polycarbonate. The thicknesses of the three substrates must furthermore be adapted so that the SWR. of the assembly is as close as possible to 1 so as to minimize the radioelectrical mismatching losses. The calculations of the matching thicknesses form part of the prior art in the field of microwaves.

The median substrate 25 may be replaced by air provided that the external substrates 26, 27 are mechanically held in an adequate manner.

The stacking of the systems of wires is not limited to two as illustrated in FIG. 2. In particular, it is possible, if necessary, to add one or more other interposed systems, provided especially that the microwave matching intervals are complied with.

Advantageously, an electrical current may go through the assembly or a part of the wires 2 of the system. The heating of the wires thus produced may defrost the logo and thus make it clearly visible, especially in winter conditions. Should one or more systems be superimposed, all the systems may be crossed by a current or only the external system 21.

The invention has been described in the case where the cover must reproduce the logo of an automobile manufacturer. It can naturally be applied when the cover has to reproduce a given graphic representation. It can also be applied when the radar is not fitted into a vehicle.

What is claimed is:

1. A device to conceal a radar, comprising at least one system of conductive wires perpendicular to the polarization of the wave sent out by the radar and reproducing a given graphic representation.

2. A device according to claim 1, wherein the radar is fitted into a vehicle.

3. A device according to claim 2 wherein the graphic representation is the logo of the manufacturer of the vehicle.

4. A device according to any of the above claims, comprising at least two superimposed systems of wires.

5. A device according to claim 4, wherein the systems are offset.

6. A device according to claim 5, wherein two systems of wires are offset by a half pitch.

7. A device according to any of the claims 4 to 6, wherein the first network of wires is separated from the second network of wires by a median substrate transparent to the optical waves and to the microwaves, the first network of wires being located towards the exterior of the vehicle.

8. A device according to claim 7, wherein a bottom substrate, transparent to the microwaves, sandwiches the second system of wires with the median substrate.

9. A device according to claim 8, wherein the bottom substrate is not transparent to the optical waves.

10. A device according to any of the claims 7 to 9, wherein the thickness of the median substrate is in the range of λ/2 where λ is the radar wavelength in the median substrate.

11. A device according to any of the claims 2 to 10, wherein the median substrate is air.

12. A device according to any of the above claims, wherein a system of wires is made by etching on substrate.

13. A device according to any of the claims 1 to 11, wherein a network of wires is made by metallization on a substrate.

14. A device according to any of the above claims, wherein the system of wires oriented towards the exterior of the vehicle is protected by a substrate transparent to optical waves.

15. A device according to any of the above claims, wherein the wires are made of chromium, copper, silver or gold.

16. A device according to any of the above claims, wherein all or part of the wires of a system is crossed by an electrical current to defrost the graphic representation.
